(19) United States
(12) Patent Application Publication
(10) Pub. No.: US 2020/0151813 A1
(43) Pub. Date: May 14, 2020

(54) SYSTEMS AND METHODS FOR LENDING TRANSACTIONS

(71) Applicant: CAPITAL ONE SERVICES, LLC, McLean, VA (US)

(72) Inventors: Arunkumar Natarajan, Glen Allen, VA (US); Venkata Mandali, Glen Allen, VA (US); Kim Rees, Great Falls, VA (US)

(73) Assignee: CAPITAL ONE SERVICES, LLC, McLean, VA (US)

(21) Appl. No.: 16/186,838

(22) Filed: Nov. 12, 2018

(51) Int. Cl. G06Q 40/02; G06Q 20/24

(52) U.S. Cl. CPC G06Q 40/025; G06Q 20/24

(57) ABSTRACT

The present disclosure relates to systems and methods for lending transactions. A system for lending transactions includes at least one memory storing instructions, and at least one processor configured to execute the instructions to perform operations. The operations include receiving a transaction posted to an account of an existing customer having a credit score above a threshold required by the credit service provider, a customer account associated with the existing customer having a credit limit; receiving an indication from the existing customer that the received transaction is associated with a purchase made by a non-customer; generating a transaction account having a balance associated with the transaction without verifying a credit score of the non-customer; receiving and tracking payments made by the non-customer for the transaction account; and closing the transaction account when payment of the transaction balance is complete.

### TECHNICAL FIELD

This disclosure relates generally to the field of lending transactions. More specifically, and without limitation, this disclosure relates to systems and methods for lending transactions using a credit limit of an existing credit service provider customer.

### BACKGROUND

In many instances, a person may need to purchase one or more items but have a credit history such that credit service providers may issue low credit limits or no credit limits at all. As a result, more generally, people with a limited credit history or poor credit history may have difficulties making purchases, particularly, large purchases, even if they have sufficient financial resources to pay off the transaction within a reasonable period of time.

Conventional techniques include seeking a short-term loan. However, short term-loans can result in significant financial difficulties for people due to complex fee structures and high interest rates. This combination may deter people from seeking a short-term loan in order to complete a transaction or may cause unnecessary financial trouble for people.

Additionally, credit service providers may issue high credit limits to credit-worthy people who may then utilize only a portion of the credit limit while leaving a remainder of the credit limit unused. It is therefore desirable to provide systems and methods to address these and other issues.

### SUMMARY

Systems and methods for lending transactions using a credit limit of an existing credit service provider customer are disclosed.

According to an exemplary embodiment of the present disclosure, a system for lending transactions is provided. The system includes at least one memory storing instructions, and at least one processor configured to execute the instructions to perform operations. The operations include receiving, by a credit service provider, a credit charge transaction posted to an account of an existing customer; receiving an indication from the existing customer that the received credit charge transaction is associated with a purchase made by a non-customer; generating a transaction account having a transaction balance associated with the credit charge transaction; tracking payments made by the non-customer for the transaction account; and closing the transaction account when payment of the transaction balance is complete.

According to another exemplary embodiment of the present disclosure, a computer implemented method for lending transactions is provided. The computer implemented method includes receiving, by a credit service provider, a credit charge transaction posted to an account of an existing credit service provider customer; receiving an indication from the customer that the received credit charge transaction is associated with a purchase made by a non-existing customer; generating a transaction account having a transaction balance associated with the credit charge transaction; tracking payments made for the transaction account by the non-customer; and closing the transaction account when payment of the transaction balance to the transaction account is complete.

Additional embodiments of the present disclosure include non-transitory computer-readable media storing instructions that cause one or more processors to execute any of the methods disclosed herein. The disclosure also provides a non-transitory computer readable medium storing instructions which, when executed, cause at least one processor to perform operations. The operations include: receiving, by a credit service provider, a credit charge transaction posted to an account of an existing credit service provider customer; receiving an indication from the customer that the received credit charge transaction is associated with a purchase made by a non-existing customer; generating a transaction account having a transaction balance associated with the credit charge transaction; tracking payments made for the transaction account by the non-customer; and closing the transaction account when payment of the transaction balance to the transaction account is complete.

Additional features and advantages of the present disclosure will be set forth in part in the following detailed description, and in part will be obvious from the description, or may be learned by practice of the present disclosure. The features and advantages of the present disclosure will be realized and attained by means of the elements and combinations particularly pointed out in the appended claims.

It is to be understood that the foregoing general description and the following detailed description are exemplary and explanatory only and are not restrictive of the disclosed embodiments.

### BRIEF DESCRIPTION OF THE DRAWINGS

The accompanying drawings, which comprise a part of this specification, illustrate several embodiments and, together with the description, serve to explain the principles disclosed herein. In the drawings:

FIG. 1 is a block diagram of a system for lending transactions, consistent with an example embodiment of the present disclosure.

FIG. 2 is a block diagram of a system for lending transactions, consistent with another example embodiment of the present disclosure.

FIG. 3 is a block diagram of fulfillment of payments to the system for lending transactions, consistent with another example embodiment of the present disclosure.

FIG. 4 is a flowchart of an example method for lending transactions, consistent with an example embodiment of the present disclosure.

FIG. 5 is a block diagram of an example server with which the systems, methods, and apparatuses of the present disclosure may be implemented.

FIG. 6A is a block diagram of an example user device with which the systems, methods, and apparatus of the present disclosure may be implemented.

FIG. 6B is a side view of the example user device of FIG. 6A.

### DETAILED DESCRIPTION

The disclosed embodiments relate to systems and methods for lending transactions. Accordingly, disclosed systems and methods result in an improved credit service provider systems and provide improved user experiences regarding the same. Moreover, disclosed systems and methods may allow for automation of tracking separate transactions for non-customers within an existing bank-customer account. Embodiments of the present disclosure may be implemented using at least one processor, as described below. In some embodiments, the at least one processor may comprise a microprocessor, such as a central processing unit (CPU), a graphics processing unit (GPU), or other electronic circuitry capable of carrying out the instructions of a computer program by performing the operations specified by the instructions. Alternatively or concurrently, the at least one processor may comprise one or more special-purpose devices built consistent with embodiments of the present disclosure using suitable circuit elements, e.g., one or more application-specific integrated circuits (ASICs), field-programmable gate arrays (FPGAs), or the like.

Consistent with an aspect of the present disclosure, a system for lending transactions may include at least one memory storing instructions and at least one processor configured to execute the instructions to perform operations. The system may also include a network, a credit service provider system, a customer service portal, a customer device, an existing customer, and at least one non-customer.

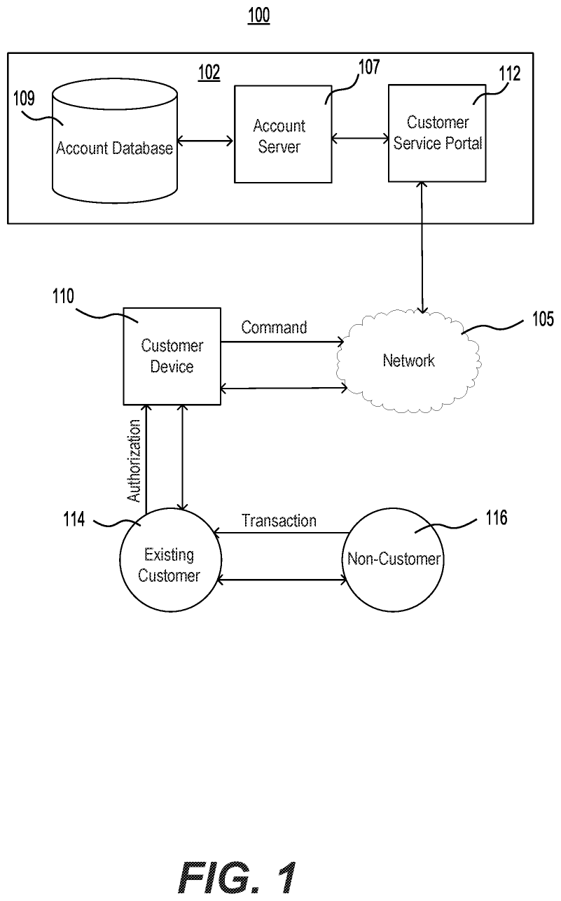

FIG. 1 is a block diagram of an exemplary system 100 for lending transactions consistent with an aspect of this disclosure. System 100 includes a system 102, of a credit service provider, having one or more account servers 107 and account databases 109, communicably connected to a customer device, e.g., a customer device 110, via a customer service portal 112 through one or more networks, e.g., a network 105. Each account database 109 may store account identifiers in association with details of accounts of customers of the credit service provider, such as transactions posted to and/or pending for the account, and identification information of the customer associated with the account (such as a name, a social security number, a physical address, an email address, a phone number, or the like). In some embodiments, each account database 109 may be encrypted such that credentials are required to access at least some information stored therein.

System 100 may be used for lending transactions consistent with the present disclosure. For example, as depicted in FIG. 1, a command from a customer device, e.g., customer device 110, may initiate a lending transaction from an existing customer 114 of the credit service provider to a non-customer 116.

The credit service provider may have a variety of criteria and thresholds established for acceptance of customers to which the credit service provider is willing to extend credit. For example, the credit service provider may have a minimum threshold of a credit score, a background check, a minimum threshold annual income, a maximum threshold amount of outstanding debt, among other qualifications. In some embodiments, existing customer 114 may have a credit score above the threshold required by the credit service provider, and the credit service provider may approve a credit limit to be associated with an account for existing customer 114.

Non-customer 116 may not be a customer of the credit service provider that controls the credit service provider system 102. For example, non-customer 116 may not meet the criteria or thresholds of the credit service provider or may not be a customer of the credit service provider for other reasons. In some embodiments, existing customer 114 may authorize a credit charge transaction associated with non-customer 116 without regard to a credit score of non-customer 116. In some embodiments, non-customer 116 and existing customer 114 may be in communication with each other and existing customer 114 may authorize the credit charge transaction for non-customer 116 at the discretion of existing customer 114 without involvement of the credit service provider.

The credit charge transaction initiated by non-customer 116 may be directly posted to an account of existing customer 114, or may be initiated by an indirect system, such as Apple Pay®, SAMSUNG Pay®, ANDROID Pay®, PAYPAL®, or other payment mechanism or method associated with existing customer 114 capable of initiating the transaction. Additionally, the transaction may be completed using cash. In such an example, existing customer 114 may authorize a cash withdrawal within a limit associated with an account of customer 114. More particularly, existing customer 114 may authorize a cash withdrawal for non-customer 116 in the same manner as the authorization of the credit charge transaction described herein. The cash withdrawal may also be tracked by the credit service provider in the same manner as the credit charge transaction, as will be discussed in more detail below.

Existing customer 114 may authorize the credit charge transaction of non-customer 116 by transmitting a request by means of customer device 110 to customer service portal 112 that the credit charge transaction is associated with a purchase made by non-customer 116. The request may be communicated from customer device 110 to customer service portal 112 of credit service provider system 102 over network 105. In response, credit service provider system 102 may apply the credit charge transaction to the credit limit of existing customer 114.

Although FIG. 1 depicts one account server 107, multiple account servers may be included in system 100. Moreover, although FIG. 1 depicts account server 107 as having one account database 109, account server 107 may have multiple associated account databases. In some embodiments, a plurality of account servers 107 may operate in tandem with distributed account databases 109. Additionally, although FIG. 1 depicts only a single customer device 110, multiple customer devices may be included in system 100. Moreover, although FIG. 1 depicts customer device 110 as having a single associated user, i.e. existing customer 114, a plurality of users may share customer device 110 and/or one existing customer 114 may have a plurality of associated customer devices. Additionally, although a single credit charge transaction has been described, a plurality of credit charge transactions may be authorized by existing customer 114 for non-customer 116 within the credit limit of existing customer 114.

In a non-limiting example, non-customer 116 may be interested in purchasing an item having a cost of $500. Existing customer 114 may lend the $500 in the form of a credit charge transaction by a credit card, issued by the credit service provider, of existing customer 114 to non-customer 116 who may not have a high enough credit score to qualify for a credit limit at or above the $500 needed to complete the credit charge transaction. Existing customer 114 may authorize the transaction via the customer device 110, which may then transmit the request through network 105 and to customer service portal 112 of credit service provider system 102. Credit service provider system 102 may apply the credit charge transaction to credit limit of existing customer 114.

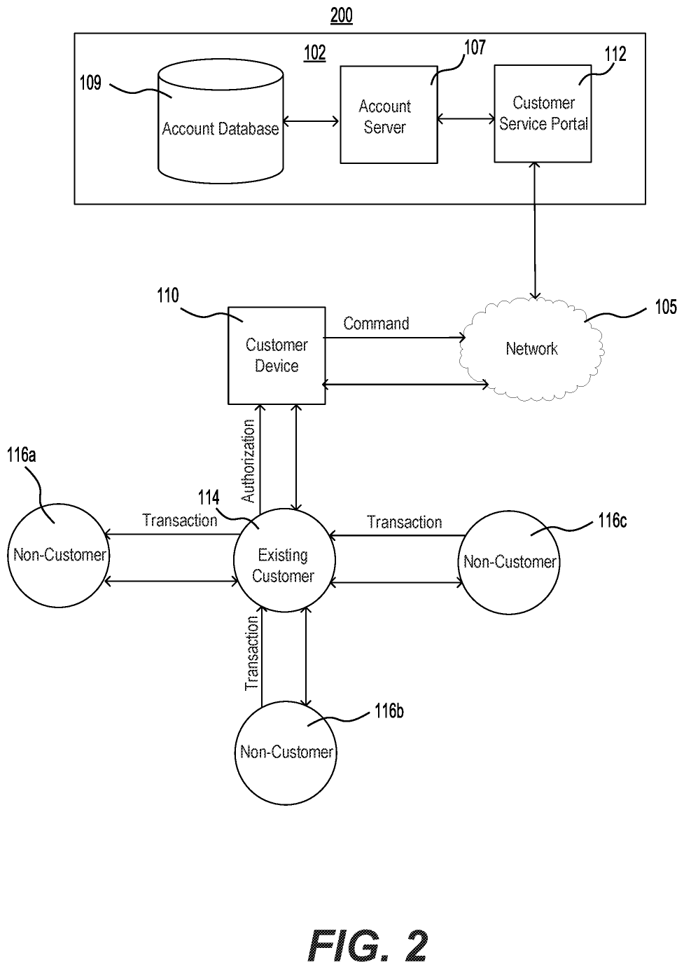

FIG. 2 illustrates a system 200 that may be used for lending transactions to a plurality of non-customers consistent with the present disclosure. For example, as depicted in FIG. 2 authorization from existing customer 114 may initiate a lending transaction from existing customer 114 to at least one of non-customers 116a, 116b, 116c. User input to customer device 110 results in a command from customer device 110 to customer service portal 112 of credit service provider system 102, over network 105. In some embodiments, non-customers 116a, 116b, 116c may request separate transactions associated with an existing customer 114 of the credit service provider.

Existing customer 114 may separately authorize credit charge transactions of non-customers 116a, 116b, 116c by transmitting a request to customer service portal 112 to associate the credit charge transactions with purchases made by non-customers 116a, 116b, 116c. The request may be communicated from the customer service portal 112 over network 105 to credit service provider system 102. Credit service provider system 102 may apply the credit charge transactions to the credit limit of existing customer 114.

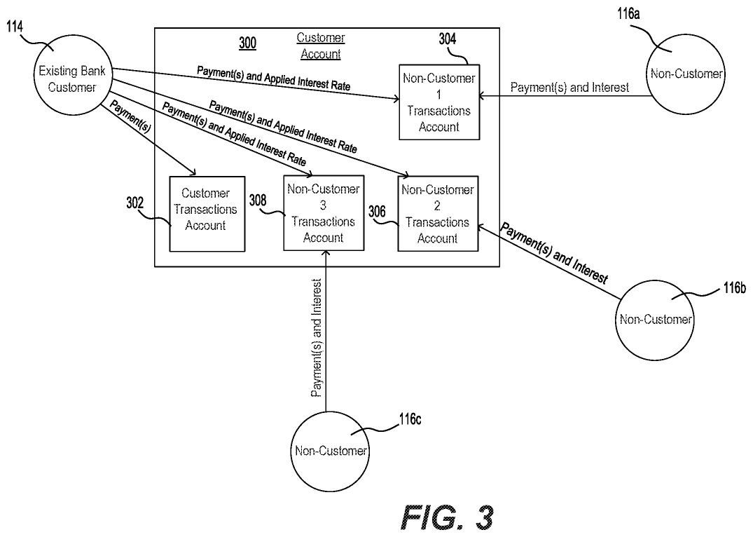

FIG. 3 illustrates an exemplary embodiment of fulfillment of payments to a system for lending transactions (e.g. system 100, system 200), consistent with the present disclosure. As discussed above, credit service provider system 102 may apply the credit charge transaction to the credit limit associated with existing customer 114, e.g. via a customer account 300. Customer account 300 may include customer transactions 302 associated with transactions posted to customer account 300 by existing customer 114. Existing customer 114 may make payments towards the customer transactions 302 which may be separated from any transactions that were associated with non-customers.

Non-customer 116a may have posted an authorized credit charge transaction to customer account 300 of existing customer 114. Credit service provider system 102 may then generate a non-customer transaction account 304 associated with the transaction or transactions posted by non-customer 116a, transaction account 304 having a balance associated with the posted transactions. Credit service provider system 102 may receive and track payments made by non-customer 116a toward the balance of transaction account 304. However, existing customer 114 remains responsible to the credit service provider for the transaction balance. Accordingly, existing customer 114 may also make payments toward, that is, for application against, the balance of non-customer transaction account 304 to the credit service provider before non-customer 116a completes payment of the outstanding balance of non-customer transaction account 304.

Credit service provider system 102 may prompt existing customer 114 for specification of an interest rate to be applied to the transaction balance of non-customer transaction account 304. The interest rate to be applied to the transaction balance of non-customer transaction account 304 may be equal to or greater than an interest rate applied by the credit service provider. Credit service provider system 102 may receive the interest rate specification from existing customer 114 and apply the specified interest rate to a remaining balance of the transaction balance of non-customer transaction account 304.

Credit service provider system 102 may track the payments made by non-customer 116a to ensure non-customer 116a fulfills payment of the balance of non-customer transaction account 304 after the credit service provider receives payments equal to the balance of non-customer transaction account 304 from existing customer 114. Credit service provider system 102 may then generate account status information (e.g. a payment history) of non-customer transaction account 304 and transmit the account status information to existing customer 114 through customer service portal 112 over network 105 for display on customer device 110 (see FIGS. 1 and 2). Credit service provider system 102 may also generate and provide statements to existing customer 114 and non-customer 116a regarding the transaction balance of non-customer transaction account 304. Non-customer 116a may access the statements provided by credit-service provider system 102 including the transaction balance and payment history of the non-customer transaction account 304. In some embodiments, the statements provided to the non-customer 116a may prompt non-customer 116a to submit payments towards the transaction balance of the non-customer account 304. Credit service provider system 102 may close non-customer transaction account 304 when payoff of the transaction balance by non-customer 116a is complete.

In some embodiments, credit service provider system 102 may generate separate transaction accounts for respective multiple credit charge transactions by the same non-customer, e.g. non-customer 116a. For example, non-customer 116a may be authorized by existing customer 114 for multiple credit charge transactions. Existing customer 114 may choose to have a separate transaction account for each respective credit charge transaction for non-customer 116a. Alternatively, existing customer 114 may choose to combine the multiple transactions for inclusion in a single transaction account (e.g. non-customer transaction account 304).

As described in reference to FIG. 2, existing customer 114 may authorize transactions for more than one non-customer (e.g. non-customers 116a, 116b, and 116c). Credit service provider system 102 may generate a non-customer transaction account (e.g. non-customer transaction accounts 304, 306, 308) for each non-customer transaction or transactions, as determined by existing customer 114. Each non-customer transaction account 304, 306, 308 may be subjected to the same process as described above. For example, credit service provider system 102 may generate non-customer transaction accounts 304, 306, 308 associated with the transaction or transactions posted by non-customers 116a, 116b, 116c, respectively. Credit service provider system 102 may receive and track payments made by non-customers 116a, 116b, 116c for their respective transaction accounts 308, 306, 304. The respective balances of non-customer transaction accounts 304, 306, 308 may be payable by non-customers 116a, 116b, 116c while existing customer 114 remains responsible to the credit service provider for the transaction balance. Credit service provider system 102 may prompt existing customer 114 for an interest rate to be applied to the transaction balance of each of non-customer transaction accounts 304, 306, 308. The interest rate for each of non-customer transaction accounts 304, 306, 308 may differ at the discretion of existing customer 114. Credit service provider system 102 may receive the interest rate from existing customer 114 and apply the received interest rate to a remaining balance of the transaction balance of non-customer transaction accounts 304, 306, 308. Credit service provider system 102 may track the payments made by non-customers 116a, 116b, 116c to ensure non-customers 116a, 116b, 116c fulfills payment of the balance of non-customer transaction accounts 304, 306, 308. Credit service provider system 102 may display a payment history of non-customer transaction accounts 304, 306, 308 to existing customer 114 via the customer service portal 112 (see FIGS. 1 and 2). Credit service provider system 102 may also provide statements to existing customer 114 and non-customers 116a, 116b, 116c regarding the transaction balance of non-customer transaction accounts 304, 306, 308. Non-customers 116a, 116b, 116c may access the statements provided by credit-service provider system 102 including the transaction balance and payment history of non-customer transaction accounts 304, 306, 308. In some embodiments, the statements provided to non-customers 116a, 116b, 116c prompt non-customers 116a, 116b, 116c to submit payments toward the transaction balance of the non-customer accounts 304, 306, 308 Credit service provider system 102 may separately close each of non-customer transaction accounts 304, 306, 308 when payment of their respective transaction balances by non-customers 116a, 116b, 116c is complete.

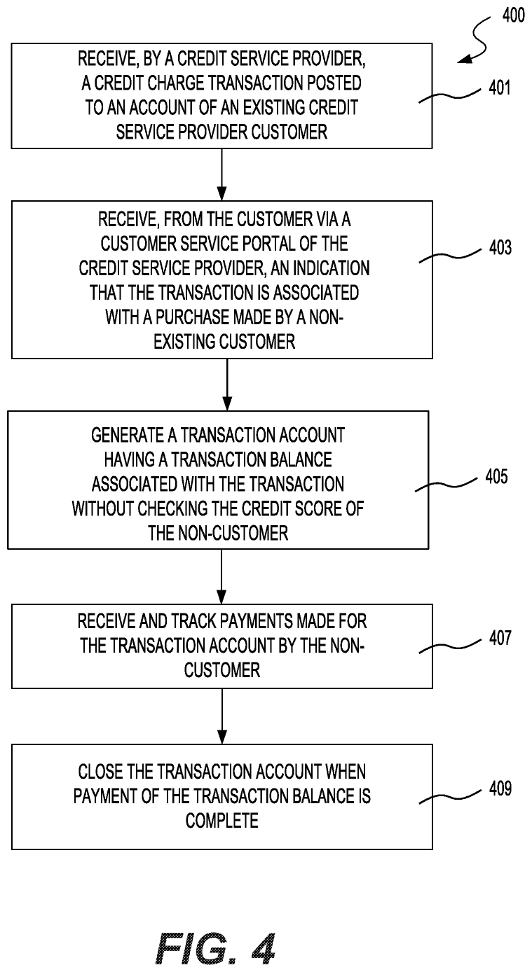

FIG. 4 is a flowchart of an example method 400 for lending transactions, consistent with an example embodiment of the present disclosure. Method 400 includes at step 401 receiving, by a credit service provider, a credit charge transaction posted to an account of an existing credit service provider customer, e.g. existing customer 114. In some embodiments, the existing customer has a credit score above a threshold required by the credit service provider, and the customer's account has a credit limit determined by the credit service provider.

The credit service provider may have a variety of criteria and thresholds established for acceptance of customers to which the credit service provider is willing to extend credit. For example, the credit service provider may have a minimum threshold of a credit score, a background check, a minimum threshold annual income, a maximum threshold amount of outstanding debt, among other qualifications. In some embodiments, existing customer may have a credit score above the threshold required by the credit service provider, and the credit service provider may approve a credit limit to be associated with an account for existing customer, e.g. existing customer 114.

At step 403, method 400 includes receiving an indication from the customer via a customer service portal of the credit service provider that the received credit charge transaction is associated with a purchase made by a non-customer. In some embodiments, the non-customer may not be a customer of the credit service provider. For example, the non-customer may not meet the criteria or thresholds of the credit service provider or may not be a customer of the credit service provider for other reasons. In some embodiments, the existing customer may authorize a credit charge transaction associated with non-customer without the existing customer or the credit service provider verifying a credit score of non-customer. In some embodiments, the non-customer and the existing customer may be in communication, and the existing customer may authorize the credit charge transaction for the non-customer at the discretion of the existing customer and without the oversight of the credit service provider. The credit charge transaction initiated by the non-customer may be posted to an account of an existing customer. The credit charge transaction may be initiated by a credit card of existing customer 114, Apple Pay®, SAMSUNG Pay®, ANDROID Pay®, PAYPAL®, or any other payment mechanism or method associated with the existing customer capable of initiating the transaction.

At step 405, method 400 includes generating a transaction account having a transaction balance associated with the credit charge transaction, the transaction account being generated without verifying a credit score of non-customer. The transaction account may have a transaction balance associated with each credit charge transaction or group of credit charge transactions separately posted by the non-customer. Additionally, separate transaction accounts may be generated for each non-customer and may have one or more transactions associated with each non-customer as authorized by the existing customer. For example, the non-customer may have posted an authorized credit charge transaction to a customer account of the existing customer, resulting in the generation of a non-customer transaction account associated with the transaction or transactions posted by the non-customer.

At step 407, method 400 includes receiving and tracking payments made for the transaction account by the non-customer. The balance of the non-customer transaction account may be payable by the non-customer, while the existing customer remains responsible to the credit service provider for the transaction balance. Accordingly, the existing customer may also make payments to the account for the balance of non-customer transaction account to the credit service provider before the non-customer completes payment of the outstanding balance of the non-customer transaction account. The method 400 may further include providing statements to the customer and non-customer, respectively, regarding the transaction balance. For example, the credit service provider system generates account status information (e.g. a payment history) of the non-customer transaction account and transmits the account status information to the existing customer through the customer service portal to display on the customer device over the network (see FIGS. 1 and 2). Credit service provider system 102 may also generate and provide statements to existing customer 114 and non-customer 116a regarding the transaction balance of non-customer transaction account 304. Non-customer 116a may access the statements provided by credit-service provider system 102 including the transaction balance and payment history of non-customer transaction account 304. In some embodiments, the statements provided to non-customer 116a prompt non-customer 116a to submit payments toward the transaction balance of the non-customer account 304.

In some embodiments, method 400 may further include prompting the customer to identify an interest rate to be applied to the transaction balance, the interest rate being equal to or greater than a rate applied by the credit service provider. Method 400 may further include applying the interest rate identified by the existing customer to a remaining balance of the transaction balance. Method 400 may further include displaying a payment history of the transaction account to the customer via the customer service portal.

In some embodiments, the credit charge transaction includes multiple credit charge transactions, and method 400 further includes generating separate transaction accounts for the respective multiple credit charge transactions authorized for non-customers. Alternatively, method 400 may combine the multiple transactions for inclusion in the transaction account for each respective non-customer separately.

At step 409, method 400 includes closing the transaction account when payment of the transaction balance of the transaction account is complete.

In some embodiments, method 400 may include multiple transactions authorized by the customer for from multiple non-customers. The method steps may repeat for each non-customer, and may occur concurrently, or at differing times.

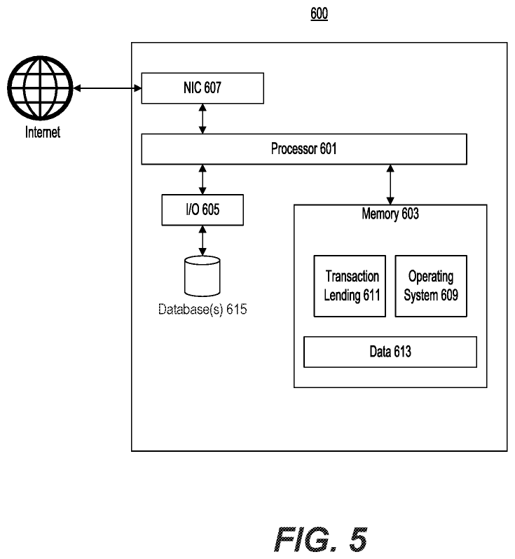

FIG. 5 is block diagram of an example device 600 suitable for implementing the disclosed systems and methods. For example, device 600 may comprise a server that executes method 400 of FIG. 4. In some embodiments, the server may include the credit service provider system 102 shown in FIGS. 1 and 2.

As depicted in FIG. 5, server 600 includes a processor 601. Processor 601 may comprise a single processor or a plurality of processors. For example, processor 601 may comprise a CPU, a GPU, a reconfigurable array (e.g., an FPGA or other ASIC), or the like.

Processor 601 may be in operable connection with a memory 603, an input/output module 605, and a network interface controller (NIC) 607. Memory 603 may comprise a single memory or a plurality of memories. In addition, memory 603 may comprise volatile memory, non-volatile memory, or a combination thereof. As depicted in FIG. 5, memory 603 may store one or more operating systems 609 and program instructions 611 for transaction lending. For example, instructions 611 may cause server 600 to execute method 400 of FIG. 4. In addition, memory 603 may store data 613 produced by, associated with, or otherwise unrelated to operating system 609 and/or instructions 611 for transaction lending.

Input/output module 605 may store and retrieve data from one or more databases 615. For example, database(s) 615 may include records associated with one or more users, e.g. accounts associated with customers and non-customers of the credit service provider as described above, at least one of which is updated in accordance with execution of method 400 of FIG. 4.

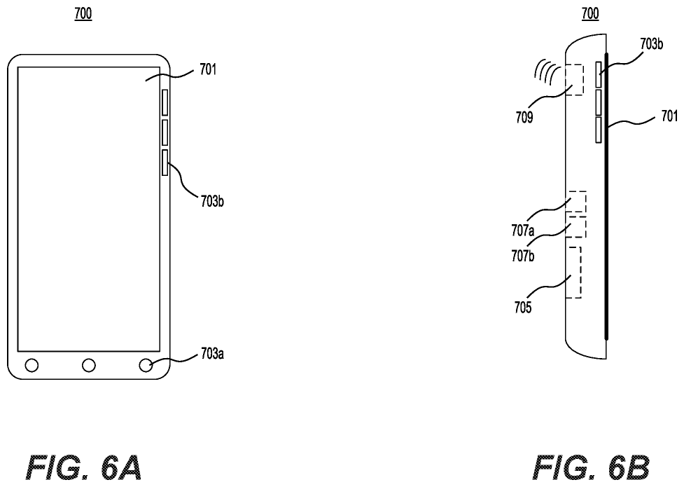

NIC 607 may connect server 600 to one or more computer networks. In the example of FIG. 6, NIC 607 connects server 600 to the Internet. Thus, the Internet may correspond to or be connected with network 105. Server 600 may transmit and receive data and instructions over a network using NIC 607.

Each of the above identified methods, instructions, and steps may correspond to a set of instructions for performing one or more functions described above. These instructions need not be implemented as separate software programs, procedures, or modules. Disclosed memories may include additional instructions or fewer instructions. Furthermore, server 600 may execute method 400 of FIG. 4. These functions of the server 600 may be implemented in hardware and/or in software, such as in one or more signal processing and/or application-specific integrated circuits.

FIG. 6A is a depiction of an exemplary user device 700 for use in lending transactions. As depicted in FIG. 6A, device 700 may comprise a smartphone. Device 700 includes a screen 701. For example, screen 701 may display one or more GUIs that allow a user to enter input authorizing and initiating lending transactions. In certain aspects, screen 701 may comprise a touchscreen to facilitate use of the one or more GUIs. In some embodiments, device 700 may be implemented as customer device 110.

As further depicted in FIG. 6A, device 700 may have one or more buttons, e.g., buttons 703a and 703b. For example, buttons 703a and 703b may facilitate use of one or more GUIs displayed on screen 701.

FIG. 6B is a side view of device 700 of FIG. 6A. As depicted in FIG. 6B, device 700 includes at least one processor 705. For example, processor 705 may comprise a system-on-a-chip (SOC) adapted for use in a portable device, such as device 700. Alternatively, or concurrently, processor 705 may comprise any other type(s) of processor.

As further depicted in FIG. 6B, device 700 includes one or more memories, e.g., memories 707a and 707b. In certain aspects, some of the memories, e.g., memory 707a, may comprise a volatile memory. In such aspects, memory 707a, for example, may store one or more applications (or “apps”) for execution on processor 705. For example, an app may include an operating system for device 700 and/or an app for executing method 400 of FIG. 4. In addition, memory 707a may store data generated by, associated with, or otherwise unrelated to an app in memory 707a.

Alternatively, or concurrently, some of the memories, e.g., memory 707b, may comprise a non-volatile memory. In such aspects, memory 707b, for example, may store one or more applications (or “apps”) for execution on at least one processor 705. For example, as discussed above, an app may include an operating system for device 700 and/or an app for authorizing transactions and displaying account statuses as described with respect to FIGS. 1-4 above. In addition, memory 707b may store data generated by, associated with, or otherwise unrelated to an app in memory 707b. Furthermore, memory 707b may include a page file, swap partition, or other allocation of storage to allow for the use of memory 707b as a substitute for a volatile memory if, for example, memory 707a is full or nearing capacity.

Although depicted as a smart phone, device 700 may alternatively comprise a tablet or other computing device having similar components.

Accordingly, the disclosed systems and methods for lending transactions enable a person (e.g. non-customer) having a low or non-existing credit limit purchase desired items. They do so by permitting a credit-worthy existing customer of a credit service provider to authorize a transaction or group of transactions for the non-customer. The existing customer thus has the ability to lend transactions to one or more non-customers within a credit limit associated with the existing customer. These transactions may allow the existing customer to utilize an increased portion of their issued credit limit.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware and software, but systems and methods consistent with the present disclosure can be implemented with hardware alone. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

Instructions or operational steps stored by a computer-readable medium may be in the form of computer programs, program modules, or codes. As described herein, computer programs, program modules, and code based on the written description of this specification, such as those used by the controller, are readily within the purview of a software developer. The computer programs, program modules, or code can be created using a variety of programming techniques. For example, they can be designed in or by means of Java, C, C++, assembly language, or any such programming languages. One or more of such programs, modules, or code can be integrated into a device system or existing communications software. The programs, modules, or code can also be implemented or replicated as firmware or circuit logic.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

Other embodiments will be apparent from consideration of the specification and practice of the embodiments disclosed herein. It is intended that the specification and examples be considered as example only, with a true scope and spirit of the disclosed embodiments being indicated by the following claims.

1. A system for lending transactions, comprising:
at least one memory storing instructions; and
at least one processor configured to execute the instructions to perform operations comprising:
receiving, by a credit service provider over a network, a credit charge transaction posted to an account of an existing customer via an encrypted account database in communication with a server of the credit service provider;
receiving, from the existing customer via a user device in communication with the server over the network, an authorization that the transaction is associated with a purchase made by a non-customer;
generating a transaction account stored on the server based on the authorization from the existing customer, the transaction account having a transaction balance associated with the transaction;
tracking payments made by the non-customer for the transaction account via the account database in communication with the server; and
closing the transaction account when payment of the transaction balance is complete.

2. The system of claim 1, the operations further comprising:
prompting the existing customer for an interest rate to be applied to the transaction balance.

3. The system of claim 2, the operations further comprising:
receiving the interest rate from the existing customer; and
applying the received interest rate to a remaining balance of the transaction balance.

4. The system of claim 1, the operations further comprising:
displaying a payment history of the transaction account to the existing customer via a customer service portal.

5. The system of claim 1, the operations further comprising:
generating statements for the existing customer and the non-customer regarding the transaction balance.

6. The system of claim 1 wherein:
the transaction comprises multiple credit charge transactions; and
the operations further comprise generating separate transaction accounts for the respective multiple transactions.

7. The system of claim 1 wherein:
the transaction comprises multiple credit charge transactions;
the operations further comprising combining the multiple transactions for inclusion in the transaction account.

8. The system of claim 1 wherein:
the transaction is initiated by a credit card of the existing customer.

9. The system of claim 1 wherein:
the transaction is applied to the credit limit of the existing customer.

10. The system of claim 1 wherein:
the transaction is a first credit charge transaction;
the transaction account is a first transaction account;
the transaction balance is a first transaction balance;
the purchase is a first purchase; and
the operations further comprise:
receiving an indication from the existing customer that a second credit charge transaction posted to the customer account is associated with a second purchase made by a second non-customer;
generating a second transaction account having a second transaction balance associated with the second transaction;
tracking payments made for the second transaction account by the second non-customer; and
closing the second transaction account when payment of the second transaction balance of the second transaction account is complete.

11. The system of claim 1 wherein:
generating a transaction account comprises generating a transaction account without verifying a credit score of the non-customer.

12. The system of claim 1 wherein:
receiving an indication from the existing customer comprises receiving the indication from the existing customer via a customer service portal.

13. A computer-implemented method for lending transactions comprising:
receiving, by a credit service provider over a network, a credit charge transaction posted to an account of an existing credit service provider customer via an encrypted account database in communication with a server of the credit service provider;
receiving an authorization from the customer via a user device in communication with the server of the credit service provider over the network that the transaction is associated with a purchase made by a non-customer;
generating a transaction account stored on the server based on the authorization from the existing customer, the transaction account having a transaction balance associated with the transaction;
tracking payments made for the transaction account by the non-customer; and
closing the transaction account when payment of the transaction balance to the transaction account is complete.

14. The computer-implemented method of claim 13 further comprising:
displaying a payment history of the transaction account to the customer via a customer service portal.

15. The computer-implemented method of claim 13 further comprising:
providing, to the customer and the non-customer, statements regarding the transaction balance.

16. The computer-implemented method of claim 13 wherein:
the transaction comprises multiple credit charge transactions;
the method further comprises generating separate transaction accounts for the respective multiple transactions.

17. The computer-implemented method of claim 13 wherein:
the transaction comprises multiple credit charge transactions;
the method further comprises combining the multiple transactions for inclusion in the transaction account.

18. The computer-implemented method of claim 13 wherein:
the transaction is a first credit charge transaction;
the non-customer is a first non-customer;
the transaction account is a first transaction account; and
the method further comprises:
receiving an indication from the customer via a customer service portal that a second credit charge transaction posted to the customer account is associated with a purchase made by a second non-customer;
generating a second transaction account having a transaction balance associated with the second transaction;
tracking payments made for the second transaction account by the second non-customer; and
closing the second transaction account when payment of the transaction balance of the second transaction account is complete.

19. The computer-implemented method of claim 13 wherein:
the transaction is initiated by a credit card of the customer.

20. A non-transitory computer-readable medium storing instructions which, when executed, cause at least one processor to perform operations comprising:
receiving, by a credit service provider over a network, a credit charge transaction posted to an account of an existing credit service provider customer via an encrypted account database in communication with a server of the credit service provider;
receiving an authorization from the customer via a user device in communication with the server of the credit service provider over the network that the transaction is associated with a purchase made by a non-customer;
generating a transaction account stored on the server based on the authorization from the existing customer, the transaction account having a transaction balance associated with the transaction;
tracking payments made for the transaction account by the non-customer; and
closing the transaction account when payment of the transaction balance to the transaction account is complete.
